(19) United States
(12) Patent Application Publication
(10) Pub. No.: US 2026/0241612 A1
(43) Pub. Date: Aug. 20, 2026

(54) LAYERED MOLD FOR DECORATIVE SHEET

(71) Applicant: Grand Force Co., Ltd., Taichung City (TW)

(72) Inventor: JUI-FEN SHIAO, Taichung City (TW)

(73) Assignee: Grand Force Co., Ltd., Taichung City (TW)

(21) Appl. No.: 19/187,997

(22) Filed: Apr. 24, 2025

(30) Foreign Application Priority Data
Feb. 19, 2025 (TW) 114106129

(51) Int. Cl. B29C 33/30; B29C 33/00; B29K 83/00; B29L 31/00

(52) U.S. Cl. CPC B29C 33/301; B29C 33/0027; B29C 33/303; B29K 2083/00; B29L 2031/722

(57) ABSTRACT

A layered mold for a decorative sheet includes a first mold and a second mold. A first mold body of the first mold has an opening surface. An injecting area is formed on the opening surface and has a peripheral edge. A plurality of injecting grooves are formed in the injecting area. Each of the injecting grooves has an injecting opening. A second mold body of the second mold has an engaging surface. A through hole penetrates through the engaging surface and has a side wall. A shape formed through the side wall surrounding is identical to a shape of the peripheral edge. When the second mold is engaged with the first mold, the engaging surface faces the opening surface and abuts against the opening surface and the side wall surrounds the peripheral edge of the injecting area.

### BACKGROUND OF THE INVENTION

### Technical Field

The present invention relates generally to a mold for forming silicone, and more particularly to a layered mold for a decorative sheet.

### Description of Related Art

A conventional way to manufacture a silicone decorative sheet with different colors and different heights is that silicone is layered through screen printing, or that a robotic arm of a dispenser sprays silicone in multiple positions in a single point manner through the dispenser with a mold positioning.

No matter the conventional way to manufacture the silicone decorative sheet is that the silicone is layered through screen printing or that the robotic arm of the dispenser sprays silicone in layers, the conventional way to manufacture the silicone decorative sheet consumes great time and a throughput is low. In addition, manufacturing the silicone decorative sheet layered with different colors or different parts of the silicone decorative sheet with different heights generates a greater manufacturing cost and a greater manufacturing time.

### BRIEF SUMMARY OF THE INVENTION

In view of the above, the primary objective of the present invention is to provide a mold which could be layered, so that a silicone decorative sheet is manufactured through sequentially injecting a liquid silicone into each layer of the mold. Therefore, a manufacturing time could be reduced, thereby raising a throughput. The decorative sheet could be manufactured in layers with different colors or could be manufactured in a three-dimensional and irregular shape.

The present invention provides a layered mold for a decorative sheet including a first mold and a second mold, wherein the first mold has a first mold body. The first mold body has an opening surface, wherein the opening surface has an edge. An injecting area is formed on the opening surface and has a peripheral edge, wherein the peripheral edge encloses in a closed shape. A plurality of injecting grooves are formed in the injecting area. Each of the injecting grooves forms an injecting opening in the injecting area. The second mold has a second mold body, wherein the second mold body has an engaging surface. A through hole is formed in the second mold body and penetrates through the engaging surface. The through hole has a side wall. A shape formed through the side wall surrounding is identical to a shape of the peripheral edge. When the second mold is engaged with the first mold, the engaging surface faces the opening surface and abuts against the opening surface, the side wall surrounds the peripheral edge of the injecting area, and the through hole communicates with the injecting openings.

When the layered mold for the decorative sheet is used, a liquid silicone is first injected into the injecting openings of the first mold, so that the liquid silicone fills the injecting grooves. Subsequently, the liquid silicone overflowing on the opening surface is removed through a scraper. Subsequently, when the second mold is engaged with the first mold, the side wall surrounds the peripheral edge of the injecting area. Subsequently, the liquid silicone is injected into the through hole of the second mold, so that the liquid silicone covers the injecting area of the first mold. Finally, the liquid silicone in the layered mold for the decorative sheet solidifies as the decorative sheet.

With the aforementioned design, through the layered mold for the decorative sheet including the first mold and the second mold, the liquid silicone is sequentially injected into the injecting grooves and the through hole, so that the liquid silicone could solidify as the decorative sheet. Therefore, a manufacturing process could be time-saving and quick, thereby raising a throughput of manufacturing the decorative sheet and the decorative sheet could be applied to objects suitable to be adhered with the decorative sheet being heated and melted, such as shoes, clothes, bags. When the liquid silicone sequentially injected into the mold of the present invention is the liquid silicone with different colors, the decorative sheet could be layered with different colors. In addition, through the injecting grooves of the first mold are designed as grooves with different lengths or different shapes, the decorative sheet made by the mold of the present invention could be in the three-dimensional and irregular shape, thereby visually showing different changes and different styles.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the layered mold for the decorative sheet according to a first embodiment of the present invention;

FIG. 2 is an exploded view of the layered mold for the decorative sheet according to the first embodiment of the present invention;

FIG. 3 is a top view of the layered mold for the decorative sheet in FIG. 1;

FIG. 4 is a sectional view along the 4-4 line in FIG. 3;

FIG. 5 is a perspective view of the first mold in FIG. 1;

FIG. 6 is a perspective view in FIG. 1, showing the second mold is engaged with the first mold;

FIG. 7 is a perspective view of the decorative sheet made by the layered mold for the decorative sheet according to the first embodiment of the present invention;

FIG. 8 is a perspective view of the decorative sheet made by the layered mold for the decorative sheet seen from another direction according to the first embodiment of the present invention;

FIG. 9 is a perspective view of the layered mold for the decorative sheet according to a second embodiment of the present invention;

FIG. 10 is a top view of the layered mold for the decorative sheet in FIG. 9;

FIG. 11 is a sectional view along the 11-11 line in FIG. 10; and

FIG. 12 is a sectional view along the 12-12 line in FIG. 10.

### DETAILED DESCRIPTION OF THE INVENTION

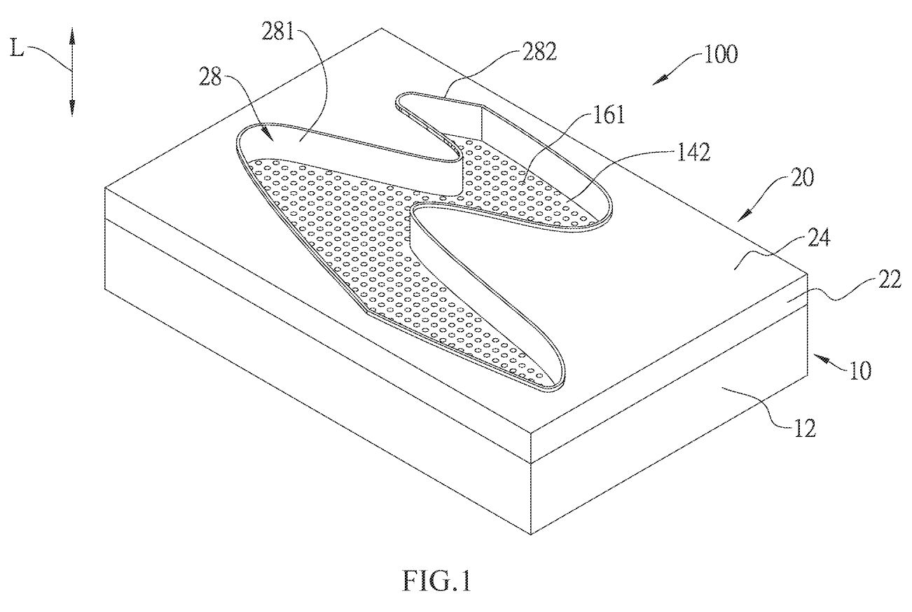

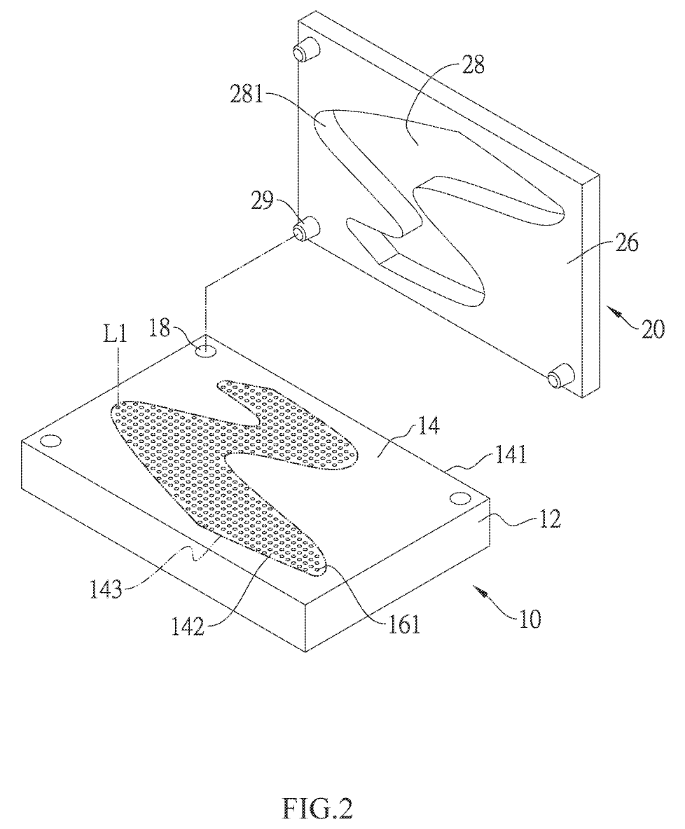

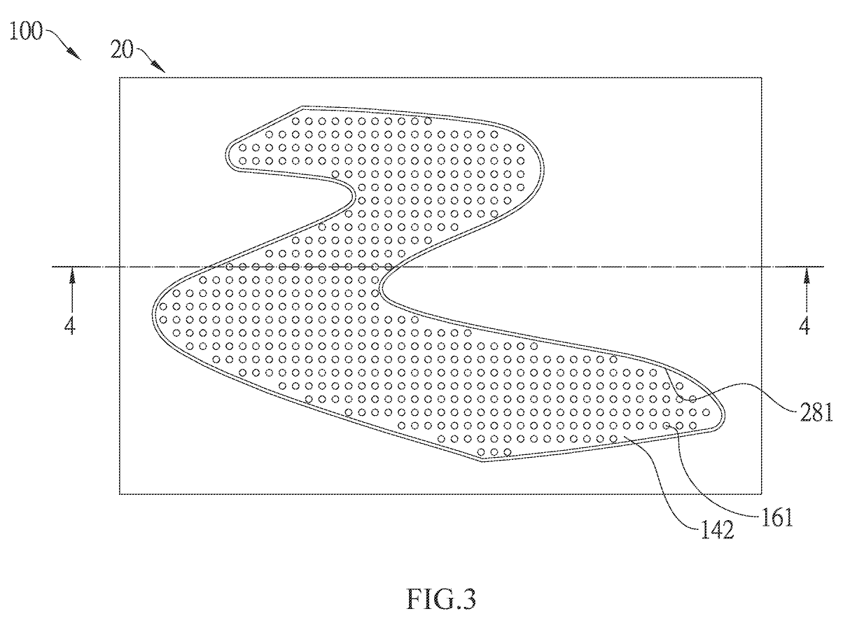

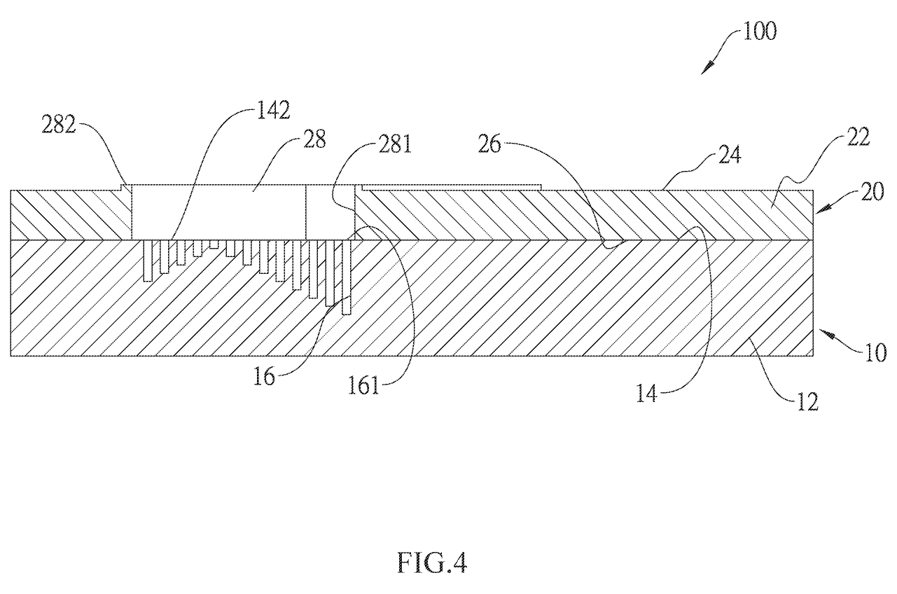

A layered mold for a decorative sheet 100 according to a first embodiment of the present invention is illustrated in FIG. 1 to FIG. 4 and includes a first mold 10 and a second mold 20, wherein the second mold 20 could be engaged with the first mold 10 in an opening and closing direction L. In the current embodiment, the opening and closing direction L is an up-down direction.

The first mold 10 includes a first mold body 12. In the current embodiment, the first mold body 12 is a rectangular board and has an opening surface 14, wherein the opening surface 14 is formed on an upper side of the first mold body 12. A periphery of the opening surface 14 has an edge 141. An injecting area 142 is formed on a middle portion of the opening surface 14. An outer periphery of the injecting area 142 has a peripheral edge 143, wherein the peripheral edge 143 encloses in a closed shape. The peripheral edge 143 and the edge 141 are spaced. In the current embodiment, the peripheral edge 143 of the injecting area 142 is S-shaped. In other embodiments, the peripheral edge 143 of the injecting area 142 could be circular or square, etc.

A plurality of injecting grooves 16 are formed in the injecting area 142. Each of the injecting grooves 16 forms an injecting opening 161 in the injecting area 142. In the current embodiment, the injecting grooves 16 are cylindrical and long grooves and are arranged in a matrix manner. One of two opposite ends of each of the injecting grooves 16 in the up-down direction is a closed end and the other end of each of the injecting grooves 16 forms the injecting opening 161. In other embodiments, the injecting grooves 16 could be columnar and long grooves, such as tapered grooves or polygonal grooves. In the current embodiment, each of the injecting grooves 16 has a central axis L1 extending in the up-down direction, wherein the central axes L1 are parallel and are respectively perpendicular to the opening surface 14. For a better positioning during the second mold 20 engaged with the first mold 10, each of three of four corners of an outer periphery of the opening surface 14 forms a positioning pin hole 18. In other embodiments, two or four positioning pin holes 18 could be formed on the outer periphery of the opening surface 14.

The second mold 20 has a second mold body 22. In the current embodiment, the second mold body 22 is a rectangular board. A top surface 24 and an engaging surface 26 are respectively formed on two opposite sides of the second mold body 22 in the up-down direction. A through hole 28 is formed in the second mold body 22. The through hole 28 penetrates through a middle portion of the top surface 24 and a middle portion of the engaging surface 26. The through hole 28 has a side wall 281. A shape formed through the side wall 281 surrounding is S-shaped and is identical to the shape of the peripheral edge 143 of the injecting area 142. A convex ring 282 is formed at a peripheral edge of an end of the through hole 28 away from the engaging surface 26 and extends away from the top surface 24. In other embodiments, the shape formed through the side wall 281 surrounding could also correspond to the shape of the peripheral edge 143 of the injecting area 142 and could be circular or square, etc. In other words, when the second mold 20 is engaged with the first mold 10, a part of the opening surface 14 surrounded by the side wall 281 is the injecting area 142 and the shape of the peripheral edge 143 of the injecting area 142 is defined by a shape of the through hole 28.

A positioning pin 29 is connected to each of three of four corners of an outer periphery of the engaging surface 26 corresponding to a shape and a position of each of the three positioning pin holes 18 of the first mold 10. In other embodiments, two or four positioning pins 29 could be connected to the outer periphery of the engaging surface 26 corresponding to the positions and a number of the positioning pin holes 18 of the first mold 10. When the second mold 20 is engaged with the first mold 10 in the opening and closing direction L, the engaging surface 26 faces the opening surface 14 and abuts against the opening surface 14. At that time, the positioning pins 29 are respectively inserted into the three positioning pin holes 18 to be positioned, the side wall 281 surrounds the peripheral edge 143 of the injecting area 142, and the through hole 28 communicates with the injecting grooves 16 through the injecting openings 161.

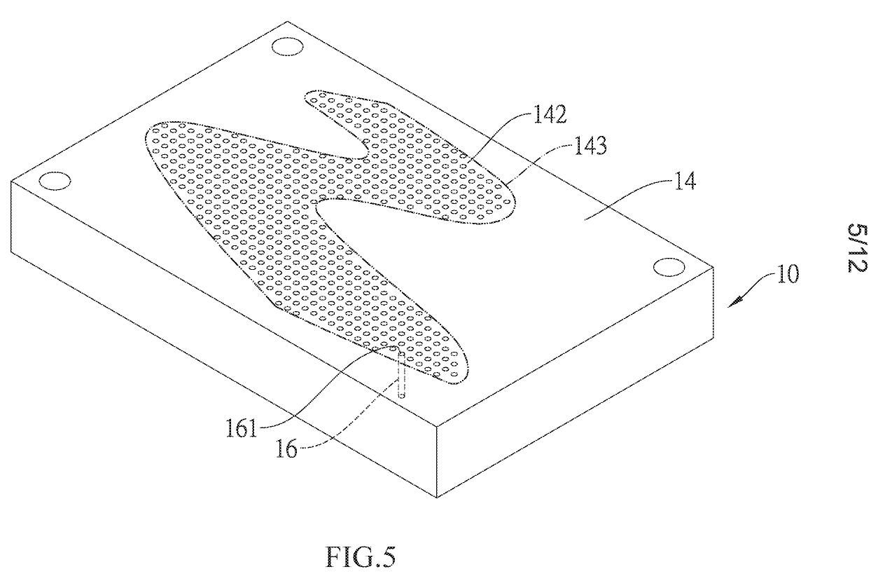

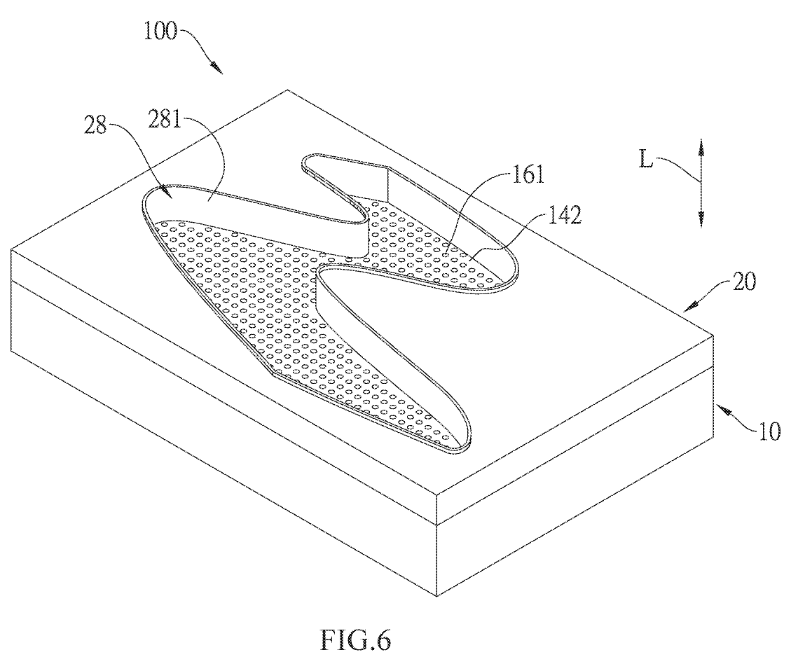

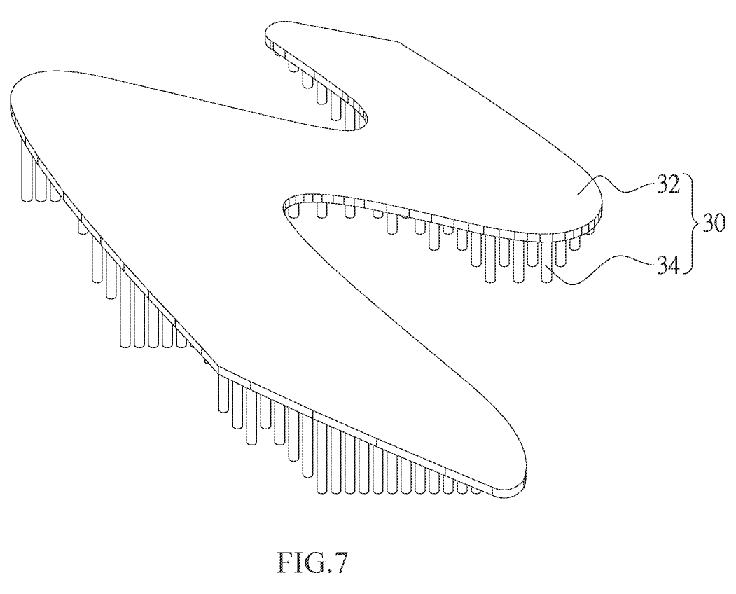

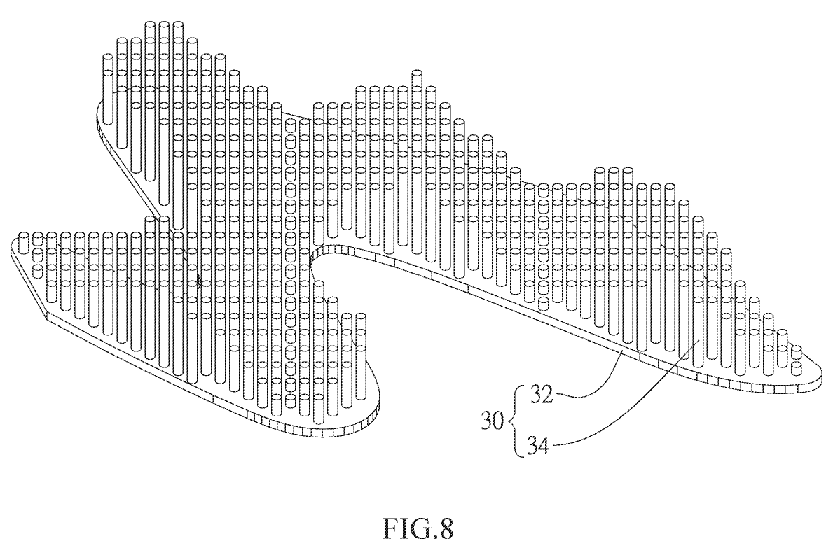

Referring to FIG. 5 to FIG. 8, when the layered mold for the decorative sheet 100 of the first embodiment of the present invention is used to manufacture a silicone decorative sheet, the first mold 10 is used alone and a liquid silicone is injected into the injecting grooves 16 through the injecting openings 161 of the first mold 10. Subsequently, the liquid silicone overflowing on the opening surface 14 is removed through a scraper smoothing the opening surface 14. Subsequently, the second mold 20 is engaged with the first mold 10 in the opening and closing direction L. At that time, the side wall 281 surrounds the peripheral edge 143 of the injecting area 142 and the through hole 28 communicates with the injecting grooves 16 through the injecting openings 161. Subsequently, the liquid silicone is injected into the through hole 28 of the second mold 20, so that the liquid silicone at least fills a bottom end of the through hole 28 and completely covers the injecting area 142 of the first mold 10.

Finally, the liquid silicone located in the first mold 10 and in the second mold 20 is heated to solidify as a decorative sheet 30. The decorative sheet 30 includes a silicone sheet 32 formed by solidifying in the through hole 28 and a plurality of silicone pieces 34 formed as long columns with different lengths through solidifying in the injecting grooves 16, wherein the silicone pieces 34 are connected to the silicone sheet 32. When the layered mold for the decorative sheet 100 of the present invention is used to manufacture the decorative sheet 30 and a color of the liquid silicone injected into the injecting grooves 16 is different from a color of the liquid silicone injected into the through hole 28, the decorative sheet 30 could have two layers with different colors.

When the layered mold for the decorative sheet 100 of the present invention is used to manufacture the decorative sheet 30, the liquid silicone is injected into the first mold 10, the liquid silicone overflowing is removed, and then the liquid silicone is injected into the second mold 20. Subsequently, the liquid silicone in the layered mold for the decorative sheet 100 could be heated to solidify as the decorative sheet 30. Therefore, a manufacturing process is time-saving, so that a throughput is great and the decorative sheet 30 could be manufactured in layers with different colors in a time-saving manner. In addition, through the injecting grooves 16 of the first mold 10 with different lengths and different shapes, the silicone pieces 34 could be manufactured with different lengths and different shapes. The silicone pieces 34 are connected to the silicone sheet 32 of the decorative sheet 30, so that the decorative sheet 30 could be manufactured in a three-dimensional and irregular shape to visually show different changes and different styles.

In addition to the first mold body 12 of the first embodiment having a single-layer structure, the first mold body 12 could have a structure including at least two layers arranged in the opening and closing direction L as the below illustration in a second embodiment of the present invention, so that the injecting grooves 16 could have multiple sections with the first mold body 12 having the at least two layers. When the decorative sheet 30 is manufactured, the silicone pieces 34 formed through the injecting grooves 16 have multiple sections with at least two different colors through the liquid silicone with different colors sequentially injected into the injecting grooves 16 of each of the at least two layers of the first mold body 12.

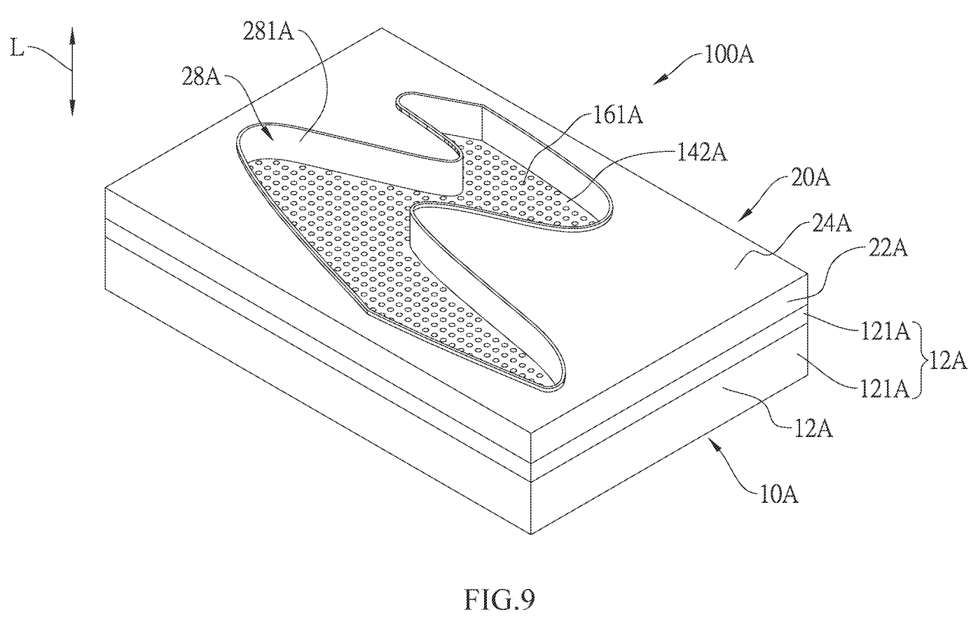

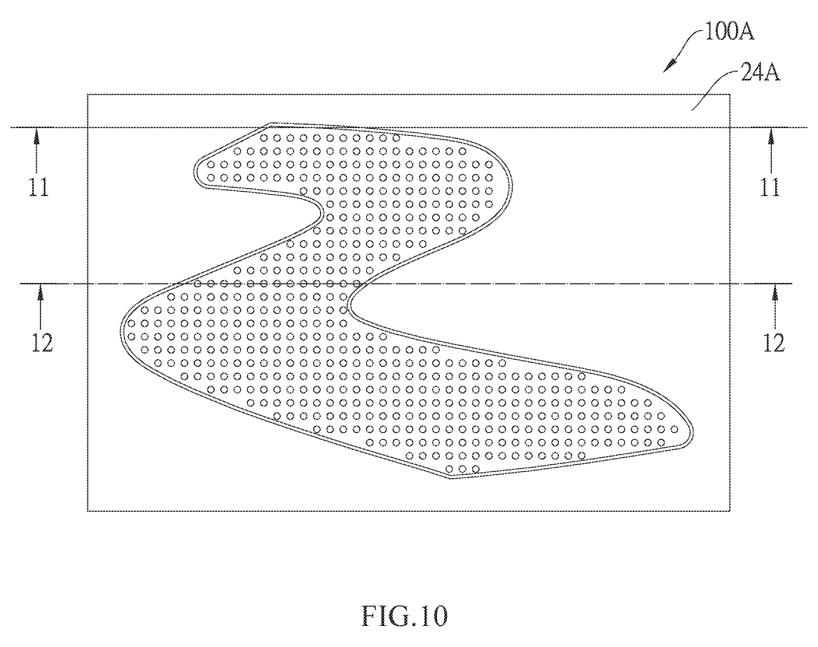

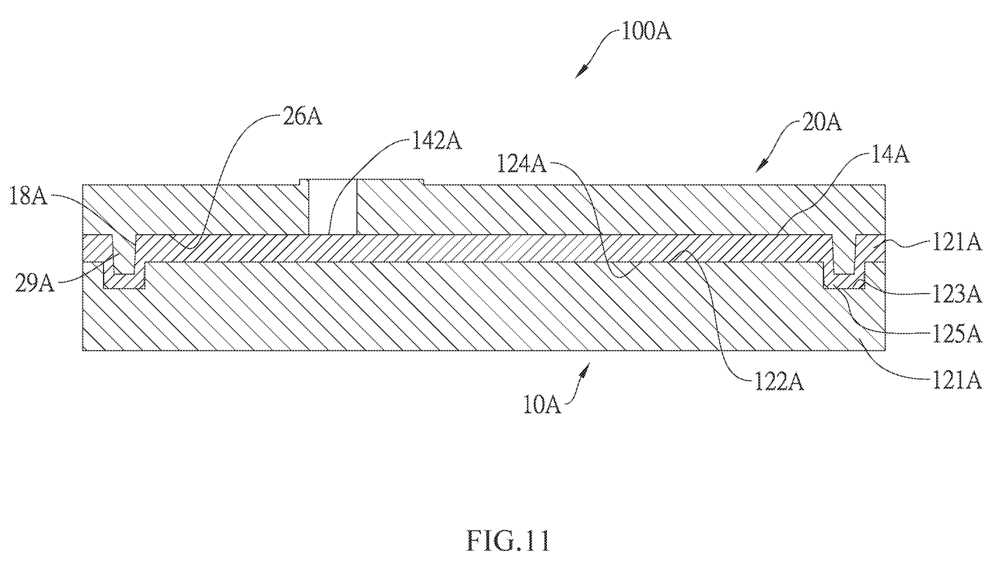

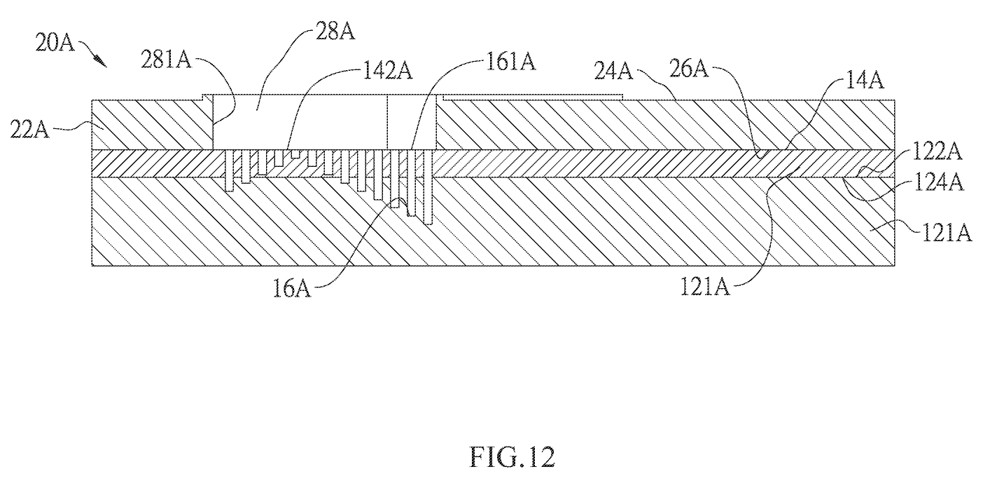

A layered mold for a decorative sheet 100A according to the second embodiment of the present invention is illustrated in FIG. 9 to FIG. 12 and has a first mold 10A and a second mold 20A, wherein the second mold 20A is adapted to be engaged with the first mold 10A in the opening and closing direction L.

The first mold 10A includes a first mold body 12A, wherein the first mold body 12A includes two boards 121A being stacked in the up-down direction. Because the two boards 121A are stacked in the up-down direction, the upper board 121A is adjacent to the lower board 121A in the up-down direction. The upper board 121A is engaged with the lower board 121A in the opening and closing direction L and a length of the upper board 121A in the opening and closing direction L is less than a length of the lower board 121A in the opening and closing direction L. Each of the two boards 121A is a rectangular board. An opening surface 14A is formed on an upper side of the upper board 121A. An injecting area 142A is formed on a middle portion of the opening surface 14A. A shape of a peripheral edge of the injecting area 142A of the second embodiment is identical to the shape of the peripheral edge 143 of the injecting area 142 of the first embodiment. A plurality of positioning pin holes 18A are formed on an outer periphery of the opening surface 14A.

The lower board 121A of the two adjacent boards 121A in the up-down direction has a board top surface 122A. A plurality of positioning grooves 123A are formed on an outer periphery of the board top surface 122A. The upper board 121A has a board bottom surface 124A. A plurality of positioning pieces 125A are connected to an outer periphery of the board bottom surface 124A. Each of the positioning pieces 125A is inserted into each of the positioning grooves 123A for positioning, so that the two boards 121A stacked in the up-down direction could be firmly positioned. In the current embodiment, a position of each of the positioning pin holes 18A formed on the upper board 121A corresponds to a position of each of the positioning pieces 125A connected to the upper board 121A. In addition, a number of the boards 121A of the first mold body 12A is, but not limited to, two. In other embodiments, when the number of the boards 121A of the first mold body 12A stacked in the up-down direction is three or four above, each of the positioning pieces 125A is also inserted into each of the positioning grooves 123A between each two adjacent boards 121A in the up-down direction.

A plurality of injecting grooves 16A are formed in the injecting area 142A and each of the injecting grooves 16A is a columnar and long groove. One of two opposite ends of each of the injecting grooves 16A in the up-down direction is a closed end and the other end of each of the injecting grooves 16A forms an injecting opening 161A. A part of the injecting grooves 16A only extends into the upper board 121A, so that the closed ends of the part of the injecting grooves 16A are located in the upper board 121A and the other part of the injecting grooves 16A penetrates through at least one of the two boards 121A. For example, in the current embodiment, because the injecting grooves 16A penetrate through the upper board 121A, the closed ends of the injecting grooves 16A are located in the lower board 121A. Overall, the closed end of each of the injecting grooves 16A is located in the one of the two boards 121A. In other embodiments, when the number of the boards 121A of the first mold body 12A stacked in the up-down direction is three or four above, the number of the boards 121A which the injecting grooves 16A penetrate through could be adjusted upon the required demand. Therefore, the closed ends of the injecting grooves 16A could be in the upper board 121A, or the closed ends of the injecting grooves 16A could penetrate through at least one of the boards 121A and could be located in any one of the boards 121A under the board 121A being penetrated.

The second mold 20A has a second mold body 22A. In the current embodiment, the second mold body 22A is a rectangular board. A top surface 24A and an engaging surface 26A are respectively formed on two opposite sides of the second mold body 22A in the up-down direction. A through hole 28A is formed in the second mold body 22A. The through hole 28A penetrates through a middle portion of the top surface 24A and a middle portion of the engaging surface 26A and has a side wall 281A. A shape formed by the side wall 281A surrounding is identical to a shape of the peripheral edge of the injecting area 142A. A plurality of positioning pins 29A are connected to an outer periphery of the engaging surface 26A corresponding to a shape and a location of each of the positioning pin holes 18A of the second mold 20A. When the second mold 20A is engaged with the first mold 10A in the opening and closing direction L, the engaging surface 26A faces the opening surface 14A and abuts against the opening surface 14A, each of the positioning pins 29A is inserted into each of the positioning pin holes 18A for positioning, and the side wall 281A surrounds the peripheral edge of the injecting area 142A, so that the through hole 28A communicates with the injecting grooves 16A through the injecting openings 161A.

When the layered mold for the decorative sheet 100A of the second embodiment is used, each of the two boards 121A of the first mold 10A is used in an order from bottom to top. The liquid silicone is first injected into a part of the injecting grooves 16A located in the lower board 121A. After the liquid silicone overflowing on the board top surface 122A is removed through the scraper, the upper board 121A is stacked on the lower board 121A and the liquid silicone is injected into the other part of the injecting grooves 16A located in the upper board 121A. In the current embodiment, after the upper board 121A is stacked on the lower board 121A for positioning, the liquid silicone is injected into the other part of the injecting grooves 16A located in the upper board 121A. After the liquid silicone is injected into the injecting grooves 16A located in the two boards 121A, the liquid silicone overflowing on the opening surface 14A is removed through the scraper.

Subsequently, the second mold 20A is engaged with the first mold 10A in the opening and closing direction L, so that the side wall 281A of the through hole 28A surrounds the peripheral edge of the injecting area 142A and the through hole 28A communicates with the injecting grooves 16A through the injecting openings 161A. Subsequently, the liquid silicone is injected into the through hole 28A of the second mold 20A, so that the liquid silicone at least fills a bottom end of the through hole 28A and completely covers the injecting area 142A of the first mold 10A. Finally, the liquid silicone located in the first mold 10A and the second mold 20A is heated to solidify as the decorative sheet. When a color of the liquid silicone sequentially injected into the injecting grooves 16A extending into the two boards 121A is different from a color of the liquid silicone injected into the through hole 28A, the decorative sheet could have multiple layers with different colors, especially a column portion of the decorative sheet formed through solidifying in the injecting grooves 16A could have multiple sections with different colors.

It must be pointed out that the embodiments described above are only some preferred embodiments of the present invention. All equivalent structures which employ the concepts disclosed in this specification and the appended claims should fall within the scope of the present invention.

What is claimed is:

1. A layered mold for a decorative sheet, comprising:
a first mold having a first mold body, wherein the first mold body has an opening surface; the opening surface has an edge; an injecting area is formed on the opening surface and has a peripheral edge, wherein the peripheral edge encloses in a closed shape; a plurality of injecting grooves are formed in the injecting area; each of the plurality of injecting grooves forms an injecting opening in the injecting area; and
a second mold has a second mold body, wherein the second mold body has an engaging surface; a through hole is formed in the second mold body and penetrates through the engaging surface; the through hole has a side wall; a shape formed through the side wall surrounding is identical to a shape of the peripheral edge; when the second mold is engaged with the first mold, the engaging surface faces the opening surface and abuts against the opening surface, the side wall surrounds the peripheral edge of the injecting area, and the through hole communicates with the plurality of injecting openings.

2. The layered mold for the decorative sheet as claimed in claim 1, wherein each of the plurality of injecting grooves is a columnar and long groove; one of two opposite ends of each of the plurality of injecting grooves is a closed end and the other end of each of the plurality of injecting grooves forms each of the plurality of injecting openings; each of the plurality of injecting grooves has a central axis, wherein the plurality of central axes are parallel and are respectively perpendicular to the opening surface.

3. The layered mold for the decorative sheet as claimed in claim 2, wherein the shape formed through the side wall surrounding is S-shaped; a shape of the peripheral edge of the injecting area is S-shaped.

4. The layered mold for the decorative sheet as claimed in claim 1, wherein the second mold body has a top surface; the top surface and the engaging surface are respectively formed on two opposite sides of the second mold body; a convex ring is formed at a peripheral edge of an end of the through hole away from the engaging surface and extends away from the top surface.

5. The layered mold for the decorative sheet as claimed in claim 1, wherein the first mold body comprises at least two boards; the at least two boards are stacked in an up-down direction; the opening surface is formed on the upper board of the at least two boards; each of the plurality of injecting grooves is a columnar and long groove; one of two opposite ends of each of the plurality of injecting grooves is a closed end and the other end of each of the plurality of injecting grooves forms each of the plurality of injecting openings; the plurality of injecting openings extend into the upper board or penetrate through at least one of the at least two boards; each of the closed ends is located in one of the at least two boards.

6. The layered mold for the decorative sheet as claimed in claim 1, wherein the first mold body is a board; the injecting area is formed on a middle portion of the opening surface; a plurality of positioning pin holes are formed on an outer periphery of the opening surface; the second mold body is a board; the through hole penetrates through a middle portion of the engaging surface; a plurality of positioning pins are connected to an outer periphery of the engaging surface; when the second mold is engaged with the first mold, each of the plurality of positioning pins is inserted into each of the plurality of positioning pin holes for positioning.

7. The layered mold for the decorative sheet as claimed in claim 6, wherein the first mold body comprises at least two boards; the at least two boards stacked in an up-down direction; the opening surface is formed on the upper board of the at least two boards; the lower board of the two adjacent boards of the at least two boards in the up-down direction has a board top surface; a plurality of positioning grooves are formed on an outer periphery of the board top surface; the upper board has a board bottom surface; a plurality of positioning pieces are connected to an outer periphery of the board bottom surface; each of the plurality of positioning pieces is inserted into each of the plurality of positioning grooves for positioning.

8. The layered mold for the decorative sheet as claimed in claim 7, wherein each of the plurality of injecting grooves is columnar and long groove; one of two opposite ends of each of the plurality of injecting grooves is a closed end and the other end of each of the plurality of injecting grooves forms each of the plurality of injecting openings; the plurality of injecting grooves extend into the upper board or penetrate through at least one of the at least two boards; each of the closed ends is located in one of the at least two boards.

9. The layered mold for the decorative sheet as claimed in claim 8, wherein the second mold is engaged with the first mold in an opening and closing direction; the first mold body comprises two boards, wherein the two boards are stacked in the opening and closing direction; a length of the upper board of the two boards in the opening and closing direction is less than a length of the lower board of the two boards in the opening and closing direction.

10. The layered mold for the decorative sheet as claimed in claim 9, wherein the plurality of positioning pin holes are formed on the upper board; a position of each of the plurality of positioning pin holes formed on the upper board corresponds to a position of each of the plurality of positioning pieces connected to the upper board in the up-down direction.
